(19) United States
(12) Patent Application Publication
(10) Pub. No.: US 2026/0212415 A1
(43) Pub. Date: Jul. 23, 2026

(54) TIME SHIFTING SYSTEMS AND METHODS FOR PROPORTIONAL YIELD DISTRIBUTION FOR TOKENIZED INVESTMENT PRODUCTS

(71) Applicant: Franklin Templeton Companies, LLC, San Mateo, CA (US)

(72) Inventors: Michael MUIR, San Mateo, CA (US); Igor NATANZON, San Mateo, CA (US)

(73) Assignee: Franklin Templeton Companies, LLC, San Mateo, CA (US)

(21) Appl. No.: 19/451,092

(22) Filed: Jan. 16, 2026

Related U.S. Application Data
(60) Provisional application No. 63/746,533, filed on Jan. 17, 2025.

(51) Int. Cl. G06Q 40/04; G06Q 40/06

(52) U.S. Cl. CPC G06Q 40/042; G06Q 40/063; G06Q 2220/00

(57) ABSTRACT

A system and method for accurate dividend distribution in investment products using proportional yield and temporal shifting. The disclosed system and method addresses challenges arising from real-time asset transfers and multi-day compounded rates. Specifically, the system calculates adjusted balances for investors by tracking ownership intervals across blockchain transactions, ensuring precise dividend distribution even during cross-chain transfers. It de-compounds multi-day rates provided by fund administrators into daily rates and schedules dividend payments accordingly, accounting for weekends, holidays, and other non-business days. By utilizing high-precision analytics and real-time synchronization between blockchains, the system ensures that dividend accruals are fair and accurate, even during asset transfers or when compounded rates span multiple days so that investors are paid equitably based on their actual holdings, regardless of transaction timing or cross-chain events.

### RELATED APPLICATION

This application claims benefit under 35 U.S.C. § 119 (e) to U.S. Provisional Application Ser. No. 63/746,533, entitled “Time Shifting Systems And Methods For Proportional Yield Distribution For Tokenized Investment Products” filed Jan. 17, 2025.

### TECHNICAL FIELD

This invention relates to methods and systems for income distribution in tokenized financial instruments and funds using blockchain technology. Specifically, it provides a novel methodology for proportional and real-time yield distribution by leveraging precise balance snapshots and high-resolution transfer tracking across multiple blockchain networks.

### BACKGROUND OF THE INVENTION

Blockchain technology is a decentralized, distributed digital ledger that enables the secure and immutable storage of data. A key feature of blockchain systems is that they operate without a central authority to add data or maintain the ledger's integrity. Instead, data is added to the blockchain through a process where an entity broadcasts a “transaction” to a network of participating nodes. Each transaction includes the data to be recorded, along with cryptographic elements that comply with the blockchain protocol.

Upon receiving a transaction, each node in the network validates its contents. If validated, the node adds the transaction to a new block it is constructing. Over time, multiple transactions may be grouped together into a single block, and the node may continue to add other transactions that are broadcast to the network. Once the block is complete, the node publishes it to the other nodes in the network. This new block includes the transactions as well as cryptographic data that links it to the preceding block, ensuring the integrity of the blockchain and maintaining its immutability.

A critical aspect of the blockchain protocol is block mining or validation, which involves the computationally intensive task of confirming transactions within a block by solving cryptographic puzzles or employing other consensus mechanisms. The mining process requires time, and as a result, there is an inherent delay between the submission of a transaction and its inclusion in a mined block. Specifically, the timestamp of a block, which reflects the time it was mined, will not necessarily align with the timestamp of the individual transactions within the block. The block's timestamp typically represents the moment the mining process is completed, which may be several seconds or minutes after the transactions were initially broadcast to the network.

While the decentralized and distributed nature of blockchain offers significant benefits in terms of transparency and security, it also necessitates innovative solutions to address timing discrepancies, particularly in financial systems where precision and fairness are essential. For example, a fund utilizing blockchain for income distribution may need to calculate and distribute daily income to investors.

In traditional investment products, income distribution is typically based on a single calculation: the fund's holdings at a specific point in time are multiplied by the distribution rate (income as a percentage of the fund's Net Asset Value, or NAV), with the income then accrued over a longer period, such as one month. In contrast, investment products leveraging blockchain can calculate and distribute income more frequently, for example daily, utilizing the blockchain to track unit holdings and transactions. The blockchain's decentralized nature, with real-time peer-to-peer transferability of tokens (units of ownership), enables transactions to occur at any time, in any amount.

While blockchain enhances precision and security in income distribution, it also introduces new challenges. Since income traditionally depends on holdings at a fixed point in time, real-time peer-to-peer transfers of units between investors could result in inequitable income calculations. Specifically, one investor may unfairly receive more income than another due to the timing of unit transfers. For example, an investor who sells units one minute after the market close on Friday may receive distributions as though they held the assets through the market open the following Monday, resulting in an inequitable distribution of income. Similarly, the investor that purchased the units one minute after the market closes on Friday may only receive income as though they began holding the units at the market open on Monday. In such cases an unfair outcome accrues where the investor who sold the units on Friday gets all the income that accrued over the weekend even though they did not own the units.

This invention addresses these challenges by providing a scalable and fair solution for calculating income distribution for tokenized assets. It accounts for real-time transactions and the delays inherent in blockchain mining, ensuring that income is fairly distributed in accordance with each investor's real-time holdings, despite the blockchain's delay in finalizing/acknowledging transactions.

### BRIEF SUMMARY OF THE INVENTION

To address these issues, applicant has developed the disclosed proportional yield design that provides a precise, time-based income distribution system for tokenized financial products, enabling accurate proportional yield calculations even across multiple transfers within a single day. By employing balance snapshots with sub-second precision to track ownership intervals, the system ensures fair and equitable income allocation. A novel methodology for reconstructing historical balances in real-time using time-shifting to address the temporal distortion created by blockchain transaction records is introduced. Specific methodology for end-of-day (EOD) processing, balance synchronization, and cross-chain transfer reconciliation is incorporated. This approach also eliminates yield gaps caused by token transfers between different blockchain networks.

Embodiments of this invention include a snapshot balance calculation, where the day is divided into discrete time intervals associated with specific balances, allowing income distribution proportional to holding durations. This invention utilizes cross-chain synchronization that leverages a timestamp-based reconciliation method that records the outbound leg of a transfer and propagates the same timestamp to the inbound leg, preventing income loss during transfer transit. Embodiments of the invention also include multi-day rate handling that de-compounds multi-day distribution rates into precise daily yields, employing high-precision analysis to minimize errors/oversights. Finally, blockchain-specific implementations provide tailored solutions for networks such as Stellar and Ethereum Virtual Machine (EVM)-based blockchains, ensuring compatibility with various transaction structures and data retrieval methods regardless of whether the transaction crosses over different blockchain ecosystems. Together, these innovations enable a robust, adaptable, and fair income distribution framework within dynamic, blockchain-based financial ecosystems.

As outlined below, the invention provides a blockchain-based system and method for proportional yield distribution that operates across one or more distributed ledgers and supports dynamic, real-time income allocation. In one aspect, a software application communicates with investors and fund administrators to receive cryptographically secure securities data defining unique balance snapshots for each investor, including identifiers, balance data, and market-close or transfer timestamps, together with a compounded yield rate over a designated interval and a list of blockchains associated with the investor. A processor identifies time segments bounded by transfer events or market open/close, calculates an adjusted balance as a weighted sum across all segments, de-compounds multi-day rates into snapshot rates, and schedules dividend payments that accurately reflect the investor's ownership intervals. The processor also detects whether the investor is associated with prior blockchains and transmits update hashes to reconcile timestamps and balances, amending scheduled distributions in real time when holdings change.

In certain embodiments, the system generates balance snapshots with sub-second temporal resolution, enforcing a minimum one-second holding period as a temporal guardrail before any yield accrues to an interval. These snapshots delineate periods between consecutive transfers or market opening/closing times, enabling precise, time-weighted income attribution and mitigating opportunities for high-frequency transfer arbitrage.

The system further addresses cross-chain transfers implemented as a burn on a source blockchain followed by a mint on a destination blockchain. To eliminate yield gaps during in-flight periods, the processor propagates the burn timestamp into the mint transaction metadata and applies cross-chain timestamp reconciliation so that inbound and outbound legs remain synchronized for yield accrual and double-counting is avoided.

In implementations tailored to EVM-based networks, the processor reconstructs investor balance histories by estimating the block corresponding to target market timestamps using average block time from sampled blocks and iteratively adjusting until within one second of the target. For Stellar, the software retrieves ledger events in reverse chronological order to backtrack balance changes and generate pre- and post-transfer snapshots. These ledger-specific workflows enable accurate snapshot creation and adjusted balance computation across diverse blockchain environments.

The processor de-compounds multi-day compounded yield rates supplied by a fund administrator into per-day snapshot rates, including weekends and holidays, and schedules distributions only after each corresponding day has elapsed. Scheduled payments are automatically amended in real time upon detecting changes to investor balance data on any associated blockchain during the distribution cycle. In certain embodiments, the system also generates a cryptographically signed audit log recording snapshots, transfer events, and yield calculations to support regulatory or compliance review.

It is to be understood that both the foregoing general description and the following detailed description are exemplary, but are not restrictive, of the invention.

### BRIEF DESCRIPTION OF THE DRAWING

The invention is best understood from the following detailed description when read in connection with the accompanying drawing.

FIG. 1 shows three different types of end-of-day scale.

FIG. 2A shows an example of a cross-chain transfer.

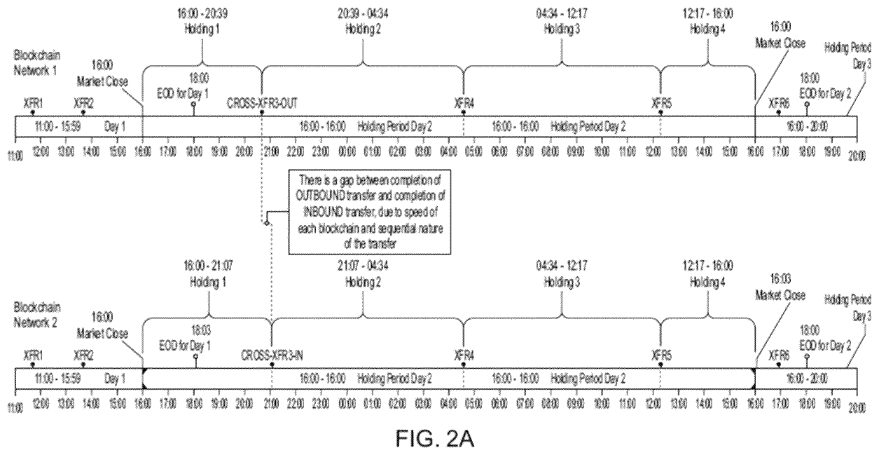

FIG. 2B shows a 30-second zoom of the cross-chain transfer of FIG. 2A.

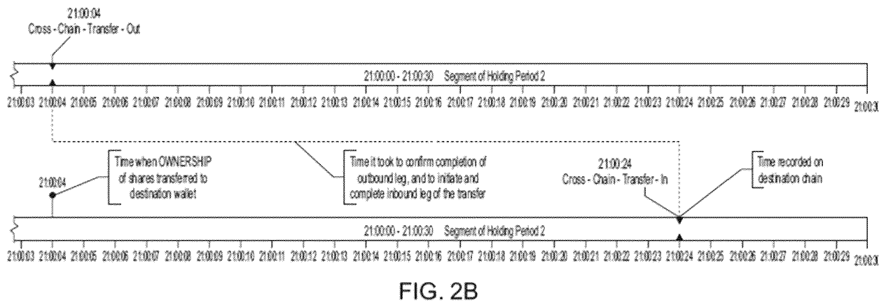

FIG. 3 shows an embodiment of the decompounding workflow described below.

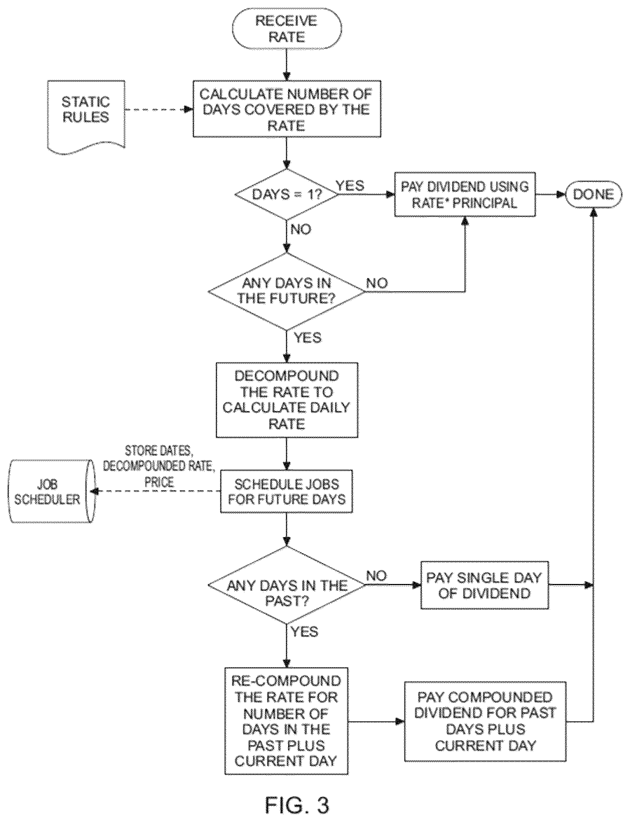

FIG. 4 shows an embodiment of the non-business day end of day process described below.

### DETAILED DESCRIPTION OF THE INVENTION

Various embodiments of the invention are described in detail below. Although specific implementations are described, this disclosure is provided for illustration purposes only. A person skilled in the relevant art will recognize that other components and configurations may be used without parting from the spirit and scope of this disclosure.

The disclosed invention offers significant advantages over traditional income distribution approaches in investment products. By leveraging blockchain technology and real-time transaction tracking, the system provides highly precise, daily income distribution that reflects actual ownership durations, ensuring fair and equitable distribution for all investors, regardless of the timing or frequency of transfers. The ability to create balance snapshots at second-level precision enables more accurate dividend calculations, addressing issues of equity that arise when transfers occur throughout the day. Additionally, the system's handling of cross-chain transfers ensures that dividends are properly allocated even during in-flight transfers between blockchains, a problem that traditional methods cannot address. The system also improves flexibility by seamlessly de-compounding multi-day distribution rates provided by the fund administrator, ensuring that dividends are paid accurately even during non-market days, such as weekends and holidays. This high-resolution, real-time approach ensures that investors receive their fair share of the income generated by the fund, with greater transparency, scalability, and fairness compared to legacy income distribution methods.

### Definitions

For purposes of this application, the term “blockchain” refers to a decentralized, distributed ledger technology that records transactions in a secure, immutable, and verifiable manner across a network of nodes. Each transaction or data entry is grouped into a “block,” linked to the previous block by cryptographic hashes, forming a continuous chain. This structure ensures data integrity and resistance to tampering. The term “blockchain” may be used interchangeably with “distributed ledger technology” (DLT) throughout this application, encompassing various implementations where consensus mechanisms enable synchronized and reliable transaction records across multiple participants without the need for a central authority.

A blockchain-based system is disclosed herein defining multiple nodes, with a journal, ledger, and a chain. At its core, blockchain is a distributed system which includes multiple nodes that communicate with each other. A blockchain in the present invention includes a sequenced list of state changes for proportional yield distribution and also operates programs called chaincode (e.g., smart contracts, etc.) which records transactions in a Yield Journal, maintains timely account data in a Yield Ledger, and executes transactions through the use of smart contracts. Some transactions are operations invoked on the chaincode. In certain embodiments, blockchain transactions typically must be “endorsed” by certain blockchain members and only endorsed transactions may be committed to the blockchain to have an effect on the state of the blockchain. Other transactions which are not endorsed may be disregarded. There may also exist one or more special chaincodes for management functions and parameters, collectively called system chaincodes.

Nodes are the communication entities of the blockchain system. A “node” may perform a logical function in the sense that multiple nodes of different types can run on the same physical server. Nodes are grouped in trust domains and are associated with logical entities that control them in various ways. Nodes may include different types, such as a investor or submitting-investor node which submits a transaction-invocation to an endorser (e.g., peer), and broadcasts transaction-proposals to an ordering service (e.g., ordering node). Another type of node is a peer node that can receive investor submitted transactions, commit the transactions and maintain a state and a copy of the ledger of blockchain transactions. Peers can also have the role of an endorser, although it is not a requirement. An ordering-service-node or orderer is a node running the communication service for all nodes, and which implements a delivery guarantee, such as a broadcast to each of the peer nodes in the system when committing transactions and modifying a world state of the blockchain, which is another name for the initial blockchain transaction that normally includes a genesis block having control and setup information.

The Yield Journal is a sequenced, tamper-resistant record of all state transitions in the yield-state blockchain. State transitions may result from chaincode invocations (i.e., transactions) submitted by participating parties (e.g., investor nodes, ordering nodes, endorser nodes, peer nodes, etc.). A transaction results in a set of asset key-value pairs being committed to the journal as one or more operands, such as creates, updates, deletes, and the like. The Yield Ledger is a virtual book of participant accounts (which may also include a blockchain) which stores an immutable, classified record of postings. There may be one Yield Ledger showing the current value of individual holdings for each “channel,” which is an investor's holdings. Each peer node maintains a copy of the ledger for each channel in a trust domain of which it is a member. A trust domain is defined by a principal relationship with the investor or the investor's intermediaries, typically to include financial agents or brokers.

A chain is a transaction log that is structured as hash-linked blocks, and each block contains a sequence of N transactions where N is equal to or greater than one. The block header includes a hash of the block's transactions, as well as a hash of the prior block's header. In this way, all transactions on the ledger may be sequenced and cryptographically linked together. Accordingly, it is not possible to tamper with the ledger data without breaking the hash links. A hash of a most recently added blockchain block represents every transaction on the chain that has come before it, making it possible to ensure that all peer nodes are in a consistent and trusted state. The chain may be stored on a peer node file system (i.e., local, attached storage, cloud, etc.), efficiently supporting the append-only nature of the blockchain workload.

The current state of the immutable ledger represents the latest values for all keys that are included in the chain transaction log. Because the current state represents the latest key values known to a channel, it is sometimes referred to as a world state. Chaincode invocations execute transactions against the current state data of the ledger. To make these chaincode interactions efficient, the latest values of the keys may be stored in a state database. The state database may be simply an indexed view into the chain's transaction log, it can therefore be regenerated from the chain at any time. The state database may automatically be recovered (or generated if needed) upon peer node startup, and before transactions are accepted.

The example embodiments below are directed to systems, methods, devices, networks, non-transitory computer readable media and/or systems, which support a blockchain solution for managing proportional yield distribution. More specifically, the present application provides a blockchain-based system for enforcing a smart contract on a network comprising one or more cryptographically-signed blocks. Some of the benefits of such a solution include streamlined risk management and regulatory compliance reporting.

### INTRODUCTION

The invention provides a solution for the present need in the art for systems, methods, and devices for precise, real-time income distribution for tokenized financial products by calculating proportional yield using sub-second balance snapshots and synchronizing cross-chain transactions to eliminate yield gaps. In certain embodiments, the disclosed system and method may be used to monitor and facilitate cross-chain transfers by propagating outbound transaction timestamps to the corresponding inbound transactions, ensuring continuous accrual of yield without income loss during the transfer process. The monitoring may be continuous or at set intervals. The invention solves the prior art problems using a computer-based platform that is specially programmed to construct and maintain dynamic and equitable real-time income distribution for tokenized financial products over a designated period of time.

The system synchronizes information from a server located at or connected to a fund administrator/accountant or advisor or an employee, contractor, or agent of the fund administrator, accountant, or advisor with the ever-changing market and investor holdings to enable precise, real-time income distribution for tokenized financial products by calculating proportional yield using balance snapshots with up to sub-second resolution and synchronizing cross-chain transactions to eliminate yield gaps.

This application utilizes time-shifting elements to solve the conundrum of how to guarantee fairness in all income distributions regardless of when the asset that generates the income is bought/sold or transferred between different blockchain ecosystems. The disclosed proportional yield design improves upon traditional income distribution methods by calculating yield based on precise time-weighted ownership intervals, rather than relying solely on static end-of-period or start-of-period holdings, ensuring more accurate and equitable income allocation. Unlike conventional systems limited to periodic or daily snapshots, this approach accommodates continuous, real-time transfers and cross-chain transactions, eliminating timing disparities and yield gaps for dynamic tokenized assets.

A detailed discussion of the methods and systems of the invention is provided below. First, a system overview is outlined. Second, non-limiting examples are provided. Third, the way a user may interact with the system is identified. Fourth, discussion of the system components occurs. Fifth, a description of a cloud computing system, the preferred environment of this system, follows. Sixth, elements to further increase the performance of the systems and methods, which may be incorporated, are delineated.

### System Overview

A system for constructing and dynamically maintaining precise, time-based balance snapshots to track ownership intervals and calculate proportional yield in real-time across multiple transactions and blockchain networks is disclosed. The system includes a software application that obtains information about portfolio holdings and a processor which determines proportional yield or income distribution based on time-weighted ownership intervals, ensuring accurate and fair allocation of returns. In certain embodiments, the processor may also update balance records, generate transaction logs, and facilitate real-time or scheduled yield payments across multiple blockchain networks.

At a high-level, the disclosed invention enables precise, fair, and automated income distribution for tokenized financial products by dynamically tracking, shifting, and calculating proportional yield based on real-time ownership changes. It captures balance snapshots with sub-second precision to reflect holding durations accurately, even as assets are transferred multiple times within a single day or across different blockchains. By synchronizing/shifting transaction timestamps and reconstructing historical balances, the system ensures continuous accrual of yield without gaps or discrepancies. Additionally, the invention handles multi-day yield rates with high-precision decompounding to minimize errors, providing a robust and scalable solution for modern, blockchain-based investment platforms.

### Balance Snapshots

The system and method first create balance snapshots by dividing a market day into discrete time intervals, each representing a period where no balance changes have occurred. A snapshot captures the number of shares or tokens held during a specific interval, which is defined by transfer events that trigger a new snapshot. Unlike traditional systems relying on static end-of-day balances, this dynamic system continuously monitors transaction activity to generate real-time snapshots with sub-second precision, enabling highly accurate yield calculations.

When a transfer occurs, the system records the timestamp of the transaction and the balance immediately before the transfer. The interval from the previous transfer or market opening to this point forms a snapshot with a defined duration and holding amount. The formula for this interval-based calculation is:

$$Snapshot Value = S \times \frac{T}{C - P} \qquad Formula 1$$

where S is the balance held, T is the duration of the snapshot in seconds, and C and P are the closing and prior market timestamps. Each transfer event splits the day into N+1 snapshots, where N is the number of transfers within the period.

To handle intra-day and cross-chain transfers effectively, the system reconstructs balance histories using blockchain transaction records. It identifies and timestamps each credit and debit event, tracking changes in real-time to compute balance snapshots accurately. Implementation differences between blockchains result in variations, for example with certain blockchains such as Stellar, transactions are processed in reverse chronological order to backtrack balance changes, while on others such as EVM-based chains, a search algorithm correlates block numbers with timestamps to locate events. These processes enable a robust, ledger-agnostic approach to snapshot creation, accommodating diverse transaction formats and timing resolutions.

In cross-chain transactions, the system mitigates yield gaps by propagating the timestamp from the outbound leg of a transfer to the inbound leg, synchronizing both events across different blockchains. The inbound snapshot uses the recorded timestamp from the originating chain rather than relying solely on the destination chain's timing, ensuring continuous ownership tracking. By integrating timestamp reconciliation into the snapshot mechanism, the system prevents income loss during transfer delays, maintaining a seamless yield accrual experience. As a result, the system dynamically creates and updates balance snapshots, supporting fair, real-time yield distribution even in highly dynamic, multi-chain environments.

### Calculating Balances

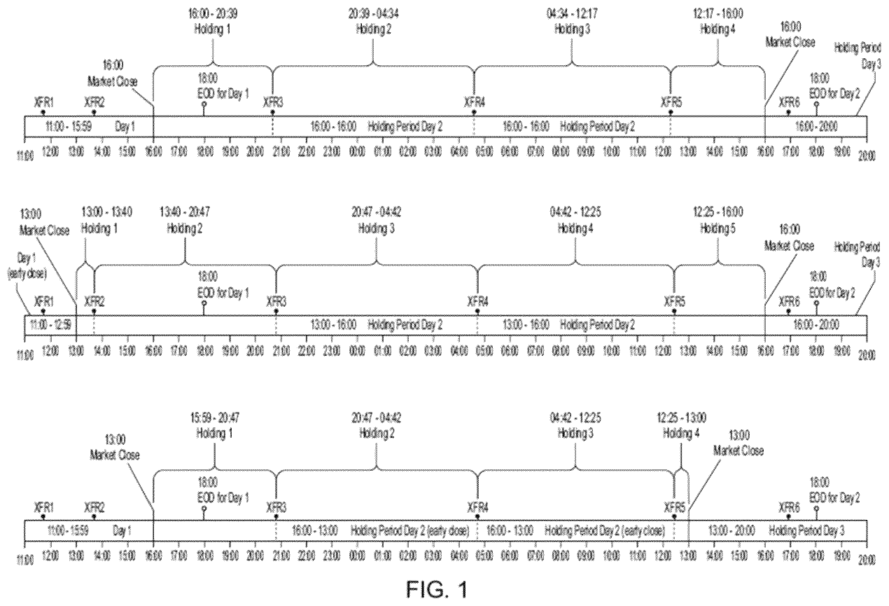

In the disclosed invention, the calculation of balances is a critical step in ensuring that dividends or income distributions are allocated fairly to each investor based on their actual holdings over time. The system calculates balances by considering the snapshots discussed above. To determine the adjusted balance for each investor, the system first identifies the relevant intervals within the distribution period. If no transfers occur during the cycle, a single snapshot interval is used, which spans from the previous market close to the current market close. However, if one or more transfers take place during the cycle, such as those depicted in FIG. 1, multiple intervals are created. For example, if a transfer occurs within the market day, two intervals are formed: one from the previous market close to the transfer time and another from the transfer time to the current market close. Each interval represents a holding period where the investor's share balance remains static, and the system calculates the precise number of shares held during each of these periods. The system then calculates the weighted shareholding for each interval using formula 1 above.

Once all snapshot intervals are calculated for an investor, the system sums the weighted balances from each interval to determine the investor's adjusted balance. The adjusted balance is the total of the weighted shares held over all intervals in the distribution cycle. This adjusted balance serves as the principal for dividend calculation, ensuring that each investor's income distribution reflects their proportional ownership over time, taking into account not only their current holdings but also the exact timing of their transfers.

Finally, the adjusted balance is used to calculate the dividend or income that the investor is entitled to receive. The dividend is computed by multiplying the adjusted balance by the applicable distribution rate provided by the fund administrator/accountant or advisor or an employee, contractor, or agent of the fund administrator, accountant, or advisor. The high precision used in the calculation of snapshot intervals ensures that dividend distributions are accurate and equitable, even when transfers occur frequently or at irregular times. This method of balance calculation provides a transparent, real-time, and fair distribution process that addresses the challenges posed by blockchain-based, real-time token transfers and eliminates the inaccuracies inherent in traditional end-of-day or start-of-day methodologies.

To ensure accuracy across different blockchain environments, the system may perform all intermediary calculations at a higher precision than is ultimately required for storage on the target blockchain. Once the final dividend or adjusted balance is determined, the value is rounded to the maximum supported precision of the respective blockchain (e.g., 7 decimals for Stellar, 18 decimals for EVM chains). This approach minimizes cumulative rounding errors and ensures that the distributed amounts are as accurate as possible within the technical constraints of each blockchain. The system dynamically detects and applies the appropriate rounding rules based on the destination chain's specifications.

### Synchronization

Because of the inherent timing issues that arise when transferring assets across different blockchains the systems and methods also engage in synchronization. Since cross-chain transfers cannot be executed in a single atomic transaction, they require a two-step process involving a burn operation on the source blockchain and a mint operation on the destination blockchain. The system ensures that the transfer occurs smoothly despite the time lag between these operations, which is crucial for ensuring that dividend distributions are accurately calculated without loss of accrual during the in-flight period of the transfer.

The process begins with validating the balance and status of the source wallet to ensure it is authorized for the transfer and is not in a frozen state. Similarly, the system validates the status of the destination wallet, ensuring that it is ready to receive the minted assets. After confirming the source and destination wallets are prepared for the transfer, the system executes the burn operation on the source wallet, removing the assets to be transferred from the source blockchain. At this stage, the burn transaction is completed, and the system waits to confirm that the operation was successful.

Next, the system retrieves the timestamp of the completed burn operation from the source blockchain by querying the wallet's transaction history. This timestamp represents the point at which the ownership of the asset on the source blockchain ends. Once the burn operation is confirmed, the system proceeds with the mint operation on the destination wallet, initiating the creation of the equivalent assets on the destination blockchain. However, to account for the time lag between the burn and mint operations, the system stores the timestamp from the burn operation in the transaction data for the mint operation. This allows the destination blockchain to accurately record the transfer's starting point, ensuring that dividends are correctly accrued for the in-flight duration of the transfer.

The system's synchronization mechanism is particularly important for dividend distribution purposes. Without this precise synchronization, the ownership of the asset on the source chain would cease at the timestamp of the burn, but the new ownership on the destination blockchain would not begin until the mint operation is completed. This gap could result in a loss of dividend accrual for the duration of the in-flight transfer. By storing the burn operation's timestamp in the mint operation's transaction on the destination blockchain, the system bridges this gap, allowing dividend calculations to account for the full duration of ownership, even during the transfer.

This synchronization approach also ensures that dividends are paid equitably across wallets, even when assets are in transit between blockchains. The time gap between the burn and mint operations is effectively eliminated, and any loss of dividend accrual due to this lag is prevented. The ability to capture and record the burn timestamp in the mint operation ensures accurate dividend distribution for cross-chain transfers and facilitates a seamless transition of ownership recordation between different blockchains.

### Blockchain Synchronization

In addition, in situations requiring EVM-based and Stellar blockchain support, the system may extend its cross-chain synchronization methodology to APTOS and Solana networks. For these blockchains, the system applies the same synchronization logic as used for EVM-based chains, wherein the completion timestamp of the outbound (burn) leg of a cross-chain transfer is recorded and propagated to the inbound (mint) transaction. This ensures that the accrual of dividends is continuous and accurate, even during the in-flight period between chains, and eliminates potential yield gaps or double-counting. By harmonizing the synchronization process across multiple blockchain platforms, the system provides a unified and reliable framework for cross-chain dividend distribution. The system's architecture is designed to be extensible, allowing for the integration of additional blockchain protocols as needed, and ensuring that the principles of fair and accurate yield distribution are maintained regardless of the underlying technology.

In certain implementations, the system records the outbound leg's completion timestamp directly in the inbound leg's transaction metadata. For example, for Stellar this is accomplished by writing the timestamp in the Memo field of the inbound transaction, using a standardized format. For EVM-based, Aptos, and Solana blockchains, the timestamp is included in the event log of the inbound transaction. This approach ensures that the start of ownership on the destination chain is accurately aligned with the end of ownership on the source chain, eliminating yield gaps and supporting precise cross-chain dividend accrual.

### Compounded Rate Handling

To improve clarity and consistency in the system's documentation and implementation, the workflow previously referred to as the “De-compounding workflow” may be designated as the “Rate de-compounder workflow.” This updated terminology more accurately reflects the function of the workflow, which is to break down multi-day compounded yield rates into precise daily rates for accurate and fair dividend distribution. The change in nomenclature may be reflected throughout the system's processes and user interfaces, ensuring that all stakeholders have a clear understanding of the workflow's purpose and operation. The rate de-compounder workflow may be responsible for parsing compounded rates provided by the fund administrator, accountant, or advisor, and allocating the appropriate daily rates to each investor's adjusted balance, even when the distribution period includes non-business days or spans multiple calendar periods.

The compound rate handling step in the disclosed system is designed to efficiently process and distribute dividends on investment products where the fund's dividend yield is provided by the fund administrator/accountant or advisor or an employee, contractor, or agent of the fund administrator, accountant, or advisor as a multi-day compounded rate, typically on a market-daily basis. The fund administrator/accountant or advisor or an employee, contractor, or agent of the fund administrator, accountant, or advisor may provide a compounded rate for periods that span multiple calendar days, such as weekends, holidays, or non-business days, which needs to be accurately de-compounded into individual daily rates for precise dividend distribution. The system ensures that this de-compounding process is applied correctly to each investor's adjusted balance, even when transfers or other events occur during the multi-day period.

First, the system identifies whether the provided rate covers just a single day or multiple days. If the rate covers a single day, the system processes it as usual, applying it directly to the adjusted balance of the investor for that day. However, if the rate spans multiple days into the future, including non-business days such as weekends or holidays, the system must break the rate down into individual daily rates to ensure fair and accurate dividend distribution because transactional activity has yet to occur for the period in question. The compounded rate is then de-compounded into daily portions, and each daily portion is applied to the corresponding investor's adjusted balance for that day after that day has elapsed.

The system also handles the case where the rate provided by the fund administrator/accountant or advisor or an employee, contractor, or agent of the fund administrator, accountant, or advisor covers both preceding and following days in cases such as when a weekend or holiday period spans over a weekend or end of the month. In this case, the rate is split into smaller portions for each day of the period covered, ensuring that no day is overlooked. For example, if the administrator provides a rate for Friday, Saturday, and Sunday, and Sunday is the last day of the month, the system ensures that Friday's rate includes Saturday and Sunday, but only until the end of the month. The system applies the compounded rate to the relevant days while following rules for how weekends and holidays are treated previously uploaded by the fund administrator/accountant or advisor or an employee, contractor, or agent of the fund administrator, accountant, or advisor.

To ensure accuracy in the de-compounding process, the system uses a high-precision approach. The de-compounding formula, which reverses the compounding formula typically used for multi-day rates, allows the system to break down the compounded rate into individual daily rates while minimizing the precision loss that could otherwise occur with large decimal values. These daily rates are then used for dividend distribution, ensuring that each investor receives the correct amount of income for the day based on their adjusted balance, even if the rate provided by the administrator covers multiple days.

Once the rate has been de-compounded into individual daily rates, the system schedules dividend distribution for future dates as previously uploaded by the fund administrator/accountant or advisor or an employee, contractor, or agent of the fund administrator, accountant, or advisor. For example, if the rate applies to a future period, the system creates scheduled jobs for each day in the future period to ensure that the correct de-compounded rate is applied on the appropriate day. The high-precision handling ensures that the calculated rates are accurate even when they need to be distributed over several days, allowing the system to handle complicated compounded yield calculations in real-time.

In certain embodiments, the system further enhances auditability and transparency by recording, for each transfer event, the transfer amount, the balance prior to the transfer, and a flag indicating whether the transfer is a cross-chain or intra-chain event. This information is logged and can be used for compliance, audit trails, and operational monitoring. The cross-chain/intra-chain flag allows the system to distinguish between transfers occurring within the same blockchain and those involving multiple blockchains, supporting more granular reporting and troubleshooting. These audit records are generated in real time as part of the end-of-day processing and are stored in a secure, tamper-evident log. The system may also provide interfaces for authorized users to review these logs for regulatory or operational purposes.

In one embodiment, the system applies a high-precision de-compounding formula that incorporates the asset price and accounts for transfers and liquidations during the compounding period. The daily rate is calculated as:

$$DailyRate = Price ( \sqrt[CompoundRate]{1 + \frac{CompoundRate}{Price}} ) - 1$$

The adjusted balance is determined by:

$$AdjustedBalance = ( StartingBalance - DayRatio ) + ( StartingBalance + NetTransferredShares ) + ( 1 - DayRatio )$$

Where DayRatio reflects the proportion of the day before and after a transfer. For cases involving liquidated shares, the final adjusted balance includes an additional term to account for the difference between the compounded and daily rates, ensuring that dividend payments accurately reflect all relevant transactions. All calculations are performed at high precision to minimize rounding errors, and the final results are rounded according to the precision supported by the target blockchain.

The system workflow for dividend calculation may proceed as follows: First, the number of days covered by the compounded rate is identified based on fund administrator rules. Next, the daily dividend rate is calculated from the compounded rate using the de-compounding formula. The adjusted balance for each investor is then determined, taking into account all relevant transfers and liquidations. Finally, the adjusted balance is fed into the daily distribution workflow, ensuring that when the daily dividend rate is applied, the correct payment is made to each investor. This process ensures that all dividend distributions are both accurate and equitable, regardless of transaction timing or frequency.

When a compounded rate covers multiple future days, the system may automatically create scheduler jobs for each day in the covered period. Each scheduler job stores the de-compounded daily rate and is triggered at the end of the corresponding day to execute the dividend distribution. This ensures that income is distributed only after each day has elapsed, and that any changes in investor balances due to transfers or redemptions are accurately reflected in the daily payout. The scheduler mechanism provides a robust framework for handling complex distribution schedules, including weekends, holidays, and month-end transitions.

### Non-Business Day End-of-Day (EOD) Process

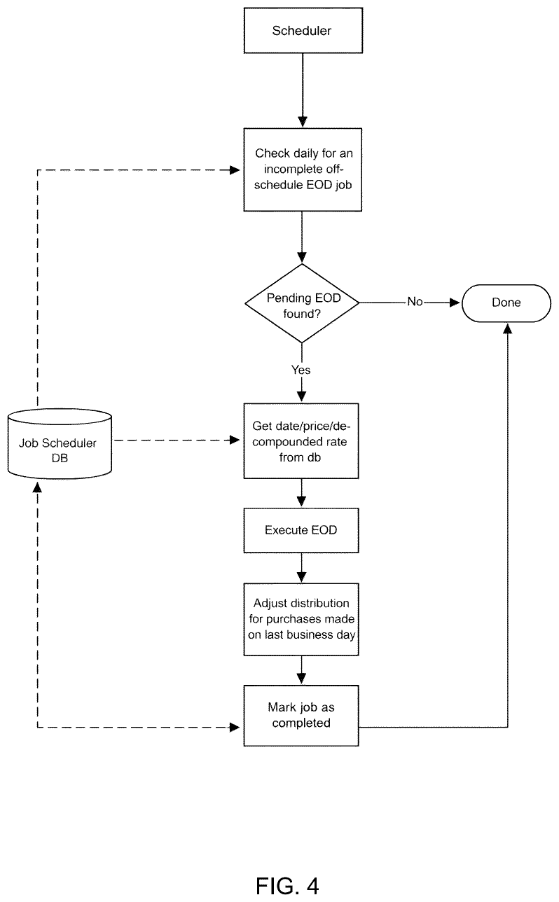

In certain embodiments, such as that depicted in FIG. 4, the system implements a specialized end-of-day (EOD) process for non-business days, such as weekends and holidays, to ensure accurate and equitable dividend distribution. When the EOD process is triggered on a non-business day, the system first determines whether the current day is classified as a non-business day based on a pre-defined calendar or schedule provided by the fund administrator, accountant, or advisor. Upon identifying a non-business day, the system queries all fully settled transactions from the last business day preceding the non-business day, including purchases, transfers, and redemptions of shares or tokens. For each account, the system temporarily adjusts the share balance by subtracting any shares or tokens that were purchased or minted on the last business day but not yet eligible for dividend accrual according to the fund's rules. This adjustment ensures that only shares or tokens held prior to the non-business day are considered for dividend calculations, thereby preventing newly acquired holdings from receiving unearned distributions during periods when the market is closed.

For clarity, “AIP” as used herein refers to “Automatic Purchases (AIP),” which are recurring investment transactions scheduled by the investor. It should be noted that the specialized EOD process described herein may be triggered only on non-business days, such as weekends and holidays. On regular business days, the standard EOD process applies, and no additional adjustments for settlement delays or ineligible shares are required.

After the share balances have been adjusted, the system executes the dividend calculation for the non-business day using the adjusted balances. The dividend rate applied may be a multi-day compounded rate that spans the non-business period, which the system de-compounds into daily rates as described elsewhere in this disclosure. Once the dividend calculation is complete and distributions are scheduled or executed, the system restores the full share balance for each account, including the previously subtracted shares or tokens. This ensures that the account records remain accurate for subsequent business days and that all transactions are properly reflected in the ledger. The non-business day EOD process thus provides a robust mechanism for handling dividend accruals during periods when markets are closed, ensuring that all investors are treated equitably and in accordance with the fund's distribution policies.

In some embodiments, the system accounts for settlement delays such as T+1 processing, where newly purchased shares are not eligible for dividend accrual until the next business day. During the end-of-day process on non-business days, the system identifies all transactions from the last business day that resulted in an increase in share balance, such as subscriptions, AIP, or inbound EOD transfers. The system temporarily subtracts these newly minted shares from the account's balance before calculating dividends for the non-business day, ensuring that only shares held prior to the non-business day are considered for income distribution. After the calculation, the full balance is restored for subsequent processing. This mechanism prevents unearned distributions and maintains compliance with fund rules regarding settlement periods.

In certain edge cases, such as during Daylight Saving Time transitions or in T+1 settlement funds, additional considerations arise. For example, when a purchase is made prior to a weekend or holiday, the shares may not be eligible to accrue dividends until the next business day. If an instant transfer of these shares occurs during the non-business period, it becomes challenging to track which shares are eligible for dividend accrual. To address this, the system may implement a “lot-based” approach, analyzing the original purchase date of each group of shares to determine eligibility. Alternatively, the system may delay the settlement of purchases until the last day of the weekend or holiday, ensuring that ineligible shares cannot be transferred and thus simplifying dividend calculations. These approaches help maintain the integrity and fairness of the yield distribution process, even in complex settlement scenarios.

### Redemption Handling and Blended Rate Calculation

The system may further incorporate a comprehensive redemption handling process to ensure fair and accurate dividend allocation for accounts that have initiated redemptions. When an account requests redemption of shares or tokens, the system may identify both the redeemed and non-redeemed portions of the account's holdings. For the purpose of dividend distribution, the system then calculates a blended dividend rate that reflects the different accrual entitlements of redeemed and non-redeemed shares. Specifically, the system allocates a portion of the dividend corresponding to future days' accrual to the redeemed shares, since these shares will not accrue further dividends after the redemption is processed. The remaining, non-redeemed shares receive only the rate for past and current days, consistent with their ongoing eligibility for future distributions.

To ensure fair dividend allocation when redemptions occur during a period covered by a multi-day compounded rate, the system calculates a blended rate as follows:

$$BlendedRate = \frac{( RedeemedShares \times FullRate ) + ( RemainingShares \times PartialRate )}{TotalShares}$$

Where FullRate is the original compounded rate, and PartialRate is the rate including only current and past days. This approach ensures that redeemed shares receive their full entitlement, including future days' accrual, while non-redeemed shares receive only the rate for elapsed days. The blended rate is applied in a single transaction, streamlining the dividend distribution process and maintaining fairness for all investors.

To implement this, the system first determines the total number of shares or tokens being redeemed and the effective date of redemption. It then calculates the dividend entitlement for the redeemed shares by applying the appropriate rate, which may include a pro rata share of future accruals if the redemption occurs during a multi-day distribution period. The system simultaneously calculates the dividend for the non-redeemed shares using only the rates applicable to the elapsed days. The blended rate is then applied in a single transaction, allowing the system to efficiently process dividend payments to both redeemed and non-redeemed shares within the same account. This approach ensures that all shares receive their full and fair entitlement, regardless of redemption activity, and that the dividend distribution process remains streamlined and transparent for all participants.

In certain embodiments when a redemption occurs during a period covered by a multi-day compounded rate, the system calculates a blended rate to ensure that redeemed shares receive their full entitlement, including future days' accrual, while non-redeemed shares receive only the rate for past and current days. The system identifies the number of shares being redeemed and applies the full compounded rate to those shares in a single transaction. For the remaining shares, only the portion of the rate corresponding to elapsed days is applied, as these shares will continue to accrue dividends in subsequent periods. This blended rate calculation ensures fairness and prevents over- or under-payment to any investor during complex distribution cycles.

### EXAMPLES

Example utilizing the Stellar and EVM environments are described below.

The disclosed system and methods may utilize the Stellar blockchain environment. To illustrate how the balance calculation works on the Stellar blockchain, consider an example where an investor, Investor A, holds tokens in a Stellar-based investment vehicle, and during a given market cycle, there are several transactions that affect their holdings. Assume that the market cycle begins at the close of the previous business day and ends at the close of the current business day, with a market close timestamp denoted as C in Formula 1 above, and the prior market close timestamp denoted as P. The system will calculate Investor A's adjusted balance based on the exact duration their tokens are held during various intervals within the cycle.

Initially, the system identifies the closing market hours for the day and retrieves the relevant credit/debit events for Investor A's wallet. In Stellar, events such as transfers, credits, and debits are recorded, and the system will begin by retrieving these events in reverse chronological order starting from the current time. If no transfers have occurred since the previous market close, the balance calculation will be straightforward, as the balance from the previous day's close will remain constant. However, if Investor A made a transfer, the system will track the transfer and calculate the balance at each specific interval before and after the transfer.

For example, if Investor A's initial holding was 1000 tokens at the market close on the previous business day (timestamp P). At a point during the day, Investor A transfers 500 tokens to another wallet. The system will then break the time between the previous market close and the current market close into two intervals: one from P to the time of the transfer, and the second from the time of the transfer to C, the current market close. The system uses Formula 1 where S is the number of tokens held during each interval, and T is the duration of the interval in seconds. For the first interval (from P to the time of the transfer), Investor A holds 1000 tokens, and for the second interval (from the time of transfer to C), Investor A holds 500 tokens. The system will calculate the weighted balance for each of these intervals based on the fraction of the total market cycle that Investor A held each amount of tokens.

Once the weighted balances for both intervals are determined, the system sums them to calculate Investor A's adjusted balance. This adjusted balance reflects the precise number of tokens held throughout the entire market cycle, accounting for the transfer that occurred mid-cycle. The adjusted balance can then be used as the principal for dividend distribution, ensuring that Investor A receives an accurate, fair share of the income generated by the fund during the period in question.

In the case of cross-chain transfers, the process would become slightly more complex due to the asynchronous nature of cross-chain transactions. However, the underlying principles remain the same—by dynamically breaking the time into accurate intervals and analyzing each holding period, the system ensures that the dividend distribution process remains fair and reflective of the actual time each investor held their tokens. The high precision of the Stellar blockchain, which allows for event retrieval in descending chronological order, ensures that even with multiple transactions, the system can reconstruct the investor's balance with accuracy.

With regard to EVM-based blockchains, consider the same example, Investor A, holds tokens in a pooled investment product, and multiple transactions occur within the market cycle. The market cycle spans from the close of the previous business day (timestamp P) to the close of the current market day (timestamp C). In this scenario, Investor A's tokens are affected by several transfers throughout the day, and the system needs to calculate the exact holding periods for each interval to ensure a fair income distribution.

Unlike Stellar, EVM-based blockchains do not have a straightforward way to retrieve transaction data in reverse chronological order, making the calculation of balance snapshots slightly more complex. To begin, the system needs to establish the timestamp of the market close P using block numbers. This is done by retrieving the latest block and identifying its timestamp, then calculating the average block time over a sample size of blocks. Using this data, the system can identify the block number corresponding to the timestamp P and proceed to identify events that occurred prior to that time, such as transfers, token transfers, or other relevant blockchain events.

Again, if Investor A initially holds 1000 tokens at the close of the previous market day, and then makes a transfer of 500 tokens to another wallet, the system will first calculate the balance before the transfer and then after the transfer. Assume the transfer occurred at timestamp T₁ during the market day. The system will create two intervals: one from P to T₁ (before the transfer) and another from T₁ to C (after the transfer). The formula used for calculating the weighted balance during these intervals remains the same—Formula 1 above—where S is the number of tokens held during the snapshot interval, and T is the duration of that interval in seconds. In the first interval (from P to T₁), Investor A holds 1000 tokens, and in the second interval (from T₁ to C), Investor A holds 500 tokens. The system will apply the formula to calculate the weighted balance for each interval based on the number of seconds each balance was held, ensuring that the distribution is proportional to the actual holding time.

When calculating the balance on an EVM blockchain, the system follows a multi-step process to determine the precise moment that the market closes and to accurately capture all relevant events during the market cycle. This process begins by determining the block numbers that correspond to the relevant timestamps. The system retrieves the latest block (Lb) and its timestamp. To estimate the timestamp for the prior market close (P), the system then retrieves a block S blocks earlier and calculates the number of seconds between the two timestamps. Using this data, the average block time (Ab) is computed by dividing the time difference by the sample size(S), which helps estimate the average time it takes for a new block to be produced.

Next, the system estimates the block number at the target timestamp P by using the formula:

$$Bp = \frac{C - P}{Ab} \qquad Formula 2$$

where C is the current timestamp and P is the timestamp of the previous market close. Once the block number Bp is identified, the system retrieves the block corresponding to this time and determines its timestamp (Bt). The goal is to bring the block timestamp as close as possible to the target timestamp P, so if Bt is greater than P, the system calculates the number of seconds it overshot by (Os), then adjusts the block number by subtracting the appropriate block offset. If Bt is less than P, the system adds the block offset to bring the timestamp closer to P. This loop continues until the block granularity is reduced to 1 second, and the system reaches a block timestamp within 1 second or earlier from the target time P.

With the precise block corresponding to the market close timestamp (P) identified, the system retrieves specific events that have occurred during the market cycle. These events can include ERC-20 token transfers, instant transfers, and cross-chain events. For each of these events, the system will reconstruct the balance at each interval by using the data from the latest balance and applying the relevant transfer event data to determine the balance at each snapshot in time. This process ensures that every moment of ownership is accounted for, even in cases where transfers occur multiple times during the cycle.

Once the system has identified all the intervals (snapshots) based on the identified events, the adjusted balance is calculated in a similar manner to the Stellar blockchain example. The weighted balances for each snapshot are summed, and the resulting adjusted balance reflects the precise holding amount for the investor throughout the entire market cycle. This adjusted balance is then used as the basis for dividend distribution, ensuring that each investor is fairly compensated for the exact amount of time they held their tokens during the market period. This method accounts for the complexities of EVM blockchains, where timestamps cannot be easily correlated with block numbers, and ensures that the balance calculation is as accurate as possible, even with complex transaction types such as cross-chain transfers and instant transfers.

### Improvements Over Prior Art

The described dynamic system represents a significant advancement over traditional static approaches to income distribution by incorporating real-time balance tracking and proportional yield calculation based on precise time-weighted ownership intervals. Traditional methods typically use a single, static end-of-day or start-or-day or otherwise daily periodic snapshot to determine income distribution, assuming that holdings remain constant throughout a defined period. This static model fails to account for frequent intra-period transfers such as those possible with blockchain based recordkeeping, leading to inequitable income allocations where some investors may receive more or less yield than they fairly earned based on their actual holding durations. The dynamic system addresses these shortcomings by capturing balance snapshots at the moment of each transfer event-even when the distributive ledger cannot-using sub-second precision to calculate yield proportional to the exact time each holding was maintained.

Furthermore, the dynamic system supports continuous peer-to-peer transfers and cross-chain transactions, solving critical limitations in traditional methods that are constrained to single-day accounting cycles and single-ledger environments. By synchronizing transaction timestamps between chains and applying a unified yield calculation model, the system ensures that yield gaps, typically caused by in-flight tokens during cross-chain transfers, are eliminated. This innovation prevents yield loss or double-counting, providing a seamless and fair experience for investors across diverse blockchain ecosystems. The dynamic, synchronized approach ensures that investors receive income precisely aligned with their holding periods, even in highly fluid, decentralized markets.

The system also improves transparency, precision, and security by leveraging blockchain transaction records for real-time balance reconstruction. Unlike traditional static systems where dividend rates are applied retroactively based on predefined time frames, the dynamic model adapts to rate changes and applies yield continuously, minimizing rounding errors through high-precision decompounding techniques. These capabilities reduce systemic inefficiencies, deter potential manipulation by high-frequency traders, and create a scalable framework for tokenized financial products that demand real-time adaptability and equitable yield distribution. Simply put, the system provides improvement in the fairness, efficiency, and technological sophistication of current income distribution models.

### System Guardrails

In certain embodiments, a temporal guardrail may be implemented. Guardrails, such as a minimum 1-second holding period for capturing balance snapshots, improve upon traditional approaches by mitigating the risk of exploitation by high-frequency traders who attempt to manipulate yield distributions through rapid, repetitive transfers. By enforcing this temporal constraint, the system prevents artificial inflation of yield entitlement from microsecond-level transactions, ensuring that income allocation accurately reflects meaningful periods of ownership. This protective measure enhances fairness and system integrity, reducing arbitrage opportunities and creating a more stable and equitable distribution mechanism compared to traditional systems that lack similar temporal precision and safeguards.

The system may be further designed to accommodate rare time-change events, such as daylight saving time adjustments or other calendar anomalies, to ensure uninterrupted and accurate dividend calculations. In such cases, the system includes logic to detect and adjust for time changes that may affect the calculation of holding intervals, snapshot timestamps, or the scheduling of dividend distributions. This may involve recalibrating the system's internal clocks, updating scheduled tasks, and ensuring that all time-based calculations remain consistent and accurate across the affected period. The system's architecture is sufficiently flexible to allow for the integration of additional rules or procedures as new types of time-change events are identified or as regulatory requirements evolve. This feature ensures that the integrity of time-based calculations is maintained, and that all investors receive their correct entitlements regardless of external time adjustments.

In certain embodiments, the system employs a timezone-aware duration calculation to determine the number of seconds in a given date range, rather than relying on a fixed value of 86,400 seconds per day. This approach ensures that the calculation of holding intervals and dividend distributions accurately reflects changes due to Daylight Saving Time (DST) transitions and leap seconds. For example, on days when DST begins or ends, the system may dynamically adjust the duration of the day to account for the one-hour increase or decrease, thereby ensuring that intraday yield distribution remains precise. The system may leverage modern date-time libraries and network time protocol (NTP) synchronization to maintain high accuracy. This feature minimizes discrepancies in yield allocation that could otherwise arise from time changes, and supports compliance with regulatory requirements for accurate time-based accounting. The system may also be configured to allow administrators to select whether to use a fixed or variable day length, depending on fund policy or jurisdictional requirements.

### System Components

A non-limiting embodiment of the system includes a general-purpose computing device, having a processing unit (CPU or processor), and a system bus that couples various system components including the system memory such as read only memory (ROM) and random-access memory (RAM) to the processor. The system can include a storage device connected to the processor by the system bus. The system can include interfaces connected to the processor by the system bus. The system can include a cache of high-speed memory connected directly with, in close proximity to, or integrated as part of the processor. The system can copy data from the memory and/or a storage device to the cache for quick access by the processor. In this way, the cache provides a performance boost that avoids processor delays while waiting for data. These and other modules stored in the memory, storage device, or cache can control or be configured to control the processor to perform various actions. Other system memory may be available for use as well. The memory can include multiple different types of memory with different performance characteristics.

### Computer Processor

The invention may operate on a computing device with more than one processor or on a group or cluster of computing devices networked together to provide greater processing capability. The processor can include any general-purpose processor and a hardware module or software module, stored in an external or internal storage device, configured to control the processor as well as a special-purpose processor where software instructions are incorporated into the actual processor design. The processor may essentially be a completely self-contained computing system, containing multiple cores or processors, a bus, memory controller, cache, etc. A multi-core processor may be symmetric or asymmetric.

For clarity purposes, an illustrative system embodiment is presented as having individual functional blocks including functional blocks labeled as a “processor.” The functions such blocks represent may be provided through the use of either shared or dedicated hardware, including, but not limited to, hardware capable of executing software and hardware, such as a processor, which is purpose-built to operate as an equivalent to software executing on a general-purpose processor. For example, the functions of one or more processors may be provided by a single shared processor or multiple processors and use of the term “processor” should not be construed to refer exclusively to hardware capable of executing software. Illustrative embodiments may include microprocessor and/or digital signal processor (DSP) hardware, read-only memory (ROM) for storing software performing the operations discussed in this document, and random-access memory (RAM) for storing results. Very large-scale integration (VLSI) hardware embodiments, as well as custom VLSI circuitry in combination with a general-purpose DSP circuit, may also be provided.

### System Bus

The system bus may be any of several types of bus structures including a memory bus or memory controller, a peripheral bus, and a local bus using any of a variety of bus architectures. A basic input/output system (BIOS) stored in ROM or the like may provide the basic routine that helps to transfer information between elements within the computing device, such as during start-up.

### Storage Device

The computing device can further include a storage device such as a hard disk drive, a magnetic disk drive, an optical disk drive, a solid-state drive, a tape drive or the like. Similar to the system memory, a storage device may be used to store data files, such as location information, menus, software, wired and wireless connection information (e.g., information that may enable the mobile device to establish a wired or wireless connection, such as a USB, Bluetooth, or wireless network connection), and any other suitable data. Specifically, the storage device and/or the system memory may store code and/or data for carrying out the disclosed techniques among other data.

In one aspect, a hardware module that performs a particular function includes the software component stored in a non-transitory computer-readable medium in connection with the necessary hardware components, such as the processor, bus, display, and so forth, to carry out the function. The basic components are known to those of skill in the art and appropriate variations are contemplated depending on the type of device, such as whether the device is a small, handheld, computing device, a desktop computer, or a computer server.

Although an embodiment described in this document uses cloud computing and cloud storage, it should be appreciated by those skilled in the art that other types of computer-readable media which can store data that are accessible by a computer, such as magnetic cassettes, flash memory cards, digital versatile disks, cartridges, random access memories (RAMS), read only memories (ROMS), a cable or wireless signal containing a bit stream and the like, may also be used in the operating environment. Furthermore, non-transitory computer-readable storage media as used in this document include all computer-readable media, with the sole exception being a transitory propagating signal per se.

### Interface

To enable user interaction with the computing device, an input device represents any number of input mechanisms, such as a microphone for speech, a web camera for video, a touch-sensitive screen for gesture or graphical input, a keyboard, a mouse, a motion input, and so forth. An output device can also be one or more of a number of output mechanisms known to those of skill in the art such as a display screen, speaker, alarm, and so forth. In some instances, multimodal systems enable a user to provide multiple types of input to communicate with the computing device. The communications interface generally governs and manages the user input and system output. Furthermore, one interface, such as a touch screen, may act as an input, output and/or communication interface.

There is no restriction on operating on any particular hardware arrangement and therefore the basic features disclosed may easily be substituted for improved hardware or firmware arrangements as they are developed.

### Software Operations

The logical operations of the various embodiments disclosed are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system can practice all or part of the recited methods, can be a part of the recited systems, and/or can operate according to instructions in the recited non-transitory computer-readable storage media. Such logical operations can be implemented as modules configured to control the processor to perform particular functions according to the programming of the module. For example, if a storage device contains modules configured to control the processor, then these modules may be loaded into RAM or memory at runtime or may be stored as would be known in the art in other computer-readable memory locations. Having disclosed some components of a computing system, the disclosure now turns to a description of cloud computing, which is the preferred environment of the invention.

### Cloud System

Cloud computing is a type of Internet-based computing in which a variety of resources are hosted and/or controlled by an entity and made available by the entity to authorized users via the Internet. A cloud computing system can be configured so that a variety of electronic devices can communicate via a network for purposes of exchanging content and other data. The system can be configured for use on a wide variety of network configurations that facilitate the intercommunication of electronic devices. For example, each of the components of a cloud computing system can be implemented in a localized or distributed fashion in a network.

### Cloud Resources

The cloud computing system can be configured to include cloud computing resources (i.e., “the cloud”). The cloud resources can include a variety of hardware and/or software resources, such as cloud servers, cloud databases, cloud storage, cloud networks, cloud applications, cloud platforms, and/or any other cloud-based resources. In some cases, the cloud resources are distributed. For example, cloud storage can include multiple storage devices. In some cases, cloud resources can be distributed across multiple cloud computing systems and/or individual network-enabled computing devices. For example, cloud computing resources can communicate with a server, a database, and/or any other network-enabled computing device to provide the cloud resources.

In some cases, the cloud resources can be redundant. For example, if cloud computing resources are configured to provide data backup services, multiple copies of the data can be stored such that the data are still available to the user even if a storage resource is offline, busy, or otherwise unavailable to process a request. In another example, if a cloud computing resource is configured to provide software, then the software can be available from different cloud servers so that the software can be served from any of the different cloud servers. Algorithms can be applied such that the closest server or the server with the lowest current load is selected to process a given request.

### User Terminal

A user interacts with cloud computing resources through user terminals or testing devices connected to a network by direct and/or indirect communication. Cloud computing resources can support connections from a variety of different electronic devices, such as servers; desktop computers; mobile computers; handheld communications devices (e.g., mobile phones, smart phones, tablets); set top boxes; network-enabled hard drives; and/or any other network-enabled computing devices. Furthermore, cloud computing resources can concurrently accept connections from and interact with multiple electronic devices. Interaction with the multiple electronic devices can be prioritized or occur simultaneously.

Cloud computing resources can provide cloud resources through a variety of deployment models, such as public, private, community, hybrid, and/or any other cloud deployment model. In some cases, cloud computing resources can support multiple deployment models. For example, cloud computing resources can provide one set of resources through a public deployment model and another set of resources through a private deployment model.

In some configurations, a user terminal can access cloud computing resources from any location where an Internet connection is available. In other cases, however, cloud computing resources can be configured to restrict access to certain resources such that a resource can only be accessed from certain locations. For example, if a cloud computing resource is configured to provide a resource using a private deployment model, then a cloud computing resource can restrict access to the resource, such as by requiring that a user terminal access the resource from behind a firewall.

### Service Models

Cloud computing resources can provide cloud resources to user terminals through a variety of service models, such as Software as a Service (SaaS), Platforms as a Service (PaaS), Infrastructure as a Service (IaaS), and/or any other cloud service models. In some cases, cloud computing resources can provide multiple service models to a user terminal. For example, cloud computing resources can provide both SaaS and IaaS to a user terminal. In some cases, cloud computing resources can provide different service models to different user terminals. For example, cloud computing resources can provide SaaS to one user terminal and PaaS to another user terminal.

### User Interaction

In some cases, cloud computing resources can maintain an account database. The account database can store profile information for registered users. The profile information can include resource access rights, such as software the user is permitted to use, maximum storage space, etc. The profile information can also include usage information, such as computing resources consumed, data storage location, security settings, personal configuration settings, etc. In some cases, the account database can reside on a database or server remote to cloud computing resources such as servers or databases.

Cloud computing resources can provide a variety of functionality that requires user interaction. Accordingly, a user interface (UI) can be provided for communicating with cloud computing resources and/or performing tasks associated with the cloud resources. The UI can be accessed via an end user terminal in communication with cloud computing resources. The UI can be configured to operate in a variety of client modes, including a fat client mode, a thin client mode, or a hybrid client mode, depending on the storage and processing capabilities of the cloud computing resources and/or the user terminal. Therefore, a UI can be implemented as a standalone application operating at the user terminal in some embodiments. In other embodiments, a web browser-based portal can be used to provide the UI. Any other configuration to access cloud computing resources can also be used in the various embodiments.

### Collection of Data

In some configurations, during the creation or maintenance of the dividend payments described above, a storage device or resource can be used to store relevant data. Examples of the data contemplated for storage are user personal data, wallet location data, and know your customer data. The data stored can be incorporated into the disclosed system and methods used to refine the data and adjust for asymmetric transfers.

### User Personal Data

The invention contemplates that, in some instances, this gathered data might include user personal and/or sensitive data. The invention further contemplates that the entities responsible for the collection, analysis, disclosure, transfer, storage, or other use of such data should implement and consistently use privacy policies and practices that are generally recognized as meeting or exceeding industry or governmental requirements for maintaining personal information and keeping data private and secure. For example, personal data from users should be collected for legitimate and reasonable uses of the entity and not shared or sold outside of those legitimate uses. Further, such collection should occur only after the informed consent of the users. In addition, such entities should take any needed steps to safeguard and secure access to such personal data and ensure that others with access to the personal data adhere to their privacy and security policies and procedures. Further, such entities can subject themselves to evaluation by third parties to certify their adherence to widely accepted privacy policies and practices.

### User Opt-Out

Despite the foregoing, the invention also contemplates embodiments in which users selectively block the use of, or access to, personal data. That is, the invention contemplates that hardware and/or software elements can be provided to prevent or block access to such personal data. For example, the present technology can be configured to allow users to select the data that are stored in cloud storage. In another example, the present technology can also be configured to allow a user to specify the data stored in cloud storage that can be shared with any fund administrator/accountant or advisor or an employee, contractor, or agent of the fund administrator, accountant, or advisor.

Therefore, although the invention broadly covers use of personal data to implement one or more various disclosed embodiments, the invention also contemplates that the various embodiments can also be implemented without the need for accessing such personal data. That is, the various embodiments of the present technology are not rendered inoperable due to the lack of all or a portion of such personal data.

While this subject matter has been disclosed with reference to specific embodiments, it is apparent that other embodiments and variations can be devised by others skilled in the art without departing from the true spirit and scope of the subject matter described herein.

What is claimed is:

1. A blockchain-based system for proportional yield distribution on a network comprising one or more cryptographically-signed blocks, the system comprising:
a software application, the application operating on a mobile computer device or on a computer device, in communication with: (a) an investor; or (b) a fund administrator, fund accountant or fund advisor or an employee, contractor, or agent of the fund administrator, fund accountant, or fund advisor, the application is configured to receive:
securities data from the fund administrator, fund accountant or fund advisor or an employee, contractor, or agent of the fund administrator, fund accountant, or fund advisor, wherein the data includes:
an investor identifier associated with the investor,
investor balance data, wherein the data includes the number of shares or tokens held by the investor during a designated time interval,
a closing market identifier associated with a current market closing time, or a transfer identifier associated with a time immediately before the investor transfers or receives shares or tokens, and
a prior closing market identifier associated with a prior market closing time,
wherein the investor identifier, investor balance data, closing market identifier, transfer identifier, and the prior closing market identifier define a unique balance snapshot, and
a compound yield rate over the designated time interval previously uploaded by the fund administrator, fund accountant or fund advisor or an employee, contractor, or agent of the fund administrator, fund accountant, or fund advisor, and
a list of blockchains previously associated with the investor identifier;
a processor in communication through the wired and/or wireless communication network with the software application, the processor is configured to:
identify time segments during which the investor holds shares or tokens, wherein each time segment is defined by a snapshot of the investor's balance prior to and following any asset transfer;
calculate an adjusted balance for the investor by determining the weighted sum of the investor's holdings of shares or tokens across all time segments;
receive the compounded yield rate and de-compounding the yield rate into snapshot rates, wherein each snapshot rate corresponds to a specific balance snapshot;
schedule dividend payments for the investor by applying the snapshot rate to the unique balance snapshot for each balance snapshot and ensuring the dividend distribution accurately reflects ownership intervals,
wherein, the software application is further configured to receive additional data and upon the receipt of additional data by the software application, the processor is further configured to query the list of blockchains to determine if the investor identifier in the additional data is associated with the an investor identifier on a prior blockchain and when the processor determines that the an investor identifier in the additional data is associated with a prior blockchain the processor is configured to generate and transmit to the prior blockchain an update hash containing an updated timestamp, and updated investor balance data, and
wherein, the processor is further configured to monitor the investor balance data on either the new blockchain or the prior blockchain and when the investor balance data changes the processor is further configured to amend the scheduled dividend payments to incorporate the change to the investor balance data in real time.

2. The system of claim 1, wherein the processor is configured to generate balance snapshots with sub-second temporal resolution, each snapshot delimiting a time segment between consecutive transfer events or market opening/closing times.

3. The system of claim 1, wherein the processor, upon detection of a cross-chain transfer comprising a burn on a source blockchain and a mint on a destination blockchain, propagates the burn timestamp to the mint transaction metadata to synchronize inbound and outbound legs for yield accrual.

4. The system of claim 1, wherein de-compounding the compounded yield rate into snapshot rates comprises reversing a multi-day compounding formula to obtain per-day rates that are applied only after the corresponding day has elapsed.

5. The system of claim 1, further comprising a temporal guardrail enforcing a minimum one-second holding period for a snapshot to be eligible for yield accrual.

6. The system of claim 1, wherein the processor reconstructs investor balance histories on an EVM-based blockchain by estimating block numbers for market timestamps using average block time and iteratively adjusting to within one second of the target time.

7. The system of claim 1, wherein the software application retrieves Stellar ledger events in reverse chronological order to backtrack balance changes and generate snapshots reflecting intervals before and after transfers.

8. The system of claim 1, wherein the processor automatically amends scheduled dividend payments in real time upon detecting an update to the investor balance data on either the prior or new blockchain during a distribution cycle.

9. The system of claim 1, wherein the processor applies cross-chain timestamp reconciliation during in-flight transfers.

10. The system of claim 1, wherein the processor is further configured to generate an audit log recording each balance snapshot, transfer event, and yield distribution calculation, the audit log being cryptographically signed to ensure data integrity and verifiability for regulatory or compliance purposes.

11. A method for proportional yield distribution on a network comprising one or more cryptographically-signed blocks, the method comprising:
receiving cryptographically secure securities data including:
an investor identifier associated with an investor,
investor balance data, wherein the data includes the number of shares or tokens held by the investor during a designated time interval,
a closing market identifier associated with a current market closing time, or a transfer identifier associated with a time immediately before the investor transfers or receives shares or tokens, and
a prior closing market identifier associated with a prior market closing time, wherein the investor identifier, investor balance data, closing market identifier, transfer identifier, and the prior closing market identifier define a unique balance snapshot, and
a compound yield rate over the designated time interval upon receiving securities data parsing the cryptographically secure securities data comprising at least:
comparing the investor identifier received with investor identifiers on previously created blockchains to identify a matching blockchain, identifying time segments during which the investor holds shares or tokens, wherein each time segment is defined by a snapshot of the investor's balance prior to and following any asset transfer;
calculating an adjusted balance for the investor by determining the weighted sum of the investor's holdings of shares or tokens across all time segments;
de-compounding the compound yield rate into snapshot rates, wherein each snapshot rate corresponds to a specific balance snapshot;
scheduling dividend payments for the investor by applying the snapshot rate to the unique balance snapshot for each balance snapshot, and ensuring the dividend distribution accurately reflects ownership intervals;
if there is a matching blockchain generating and transmitting to the matching blockchain an update hash containing an updated timestamp, and updated investor balance data, and
if there is not a matching blockchain, generating a genesis block for a new blockchain, the genesis block containing a first timestamp, an updated timestamp, and updated investor balance data.

12. The method of claim 11, further comprising generating balance snapshots at sub-second precision, each snapshot corresponding to a period without balance change and bounded by transfer events or market open/close times.

13. The method of claim 11, further comprising, for a cross-chain transfer implemented as a burn on a source chain followed by a mint on a destination chain, storing the burn timestamp in the mint transaction data to synchronize ownership start on the destination chain.

14. The method of claim 11, wherein de-compounding the compounded yield rate comprises reversing the compounding formula to derive individual daily rates for weekends, holidays, and multi-day periods, and scheduling distributions for each day after it elapses.

15. The method of claim 11, further comprising enforcing a minimum one-second snapshot duration as a temporal guardrail before attributing any yield to a holding interval.

16. The method of claim 11, wherein identifying time segments includes, on an EVM-based blockchain, estimating the block corresponding to a target market timestamp using an average block time derived from a block sample and iteratively adjusting until within one second of the target.

17. The method of claim 11, wherein identifying time segments includes, on the Stellar blockchain, retrieving credit/debit events in descending chronological order to reconstruct balances before and after intra-day transfers.

18. The method of claim 11, further comprising, upon detecting a change in investor balance data on a prior or new blockchain during the distribution cycle, amending scheduled dividend payments in real time to incorporate the change.

19. The method of claim 11, wherein synchronizing cross-chain timestamps prevents yield gaps during the in-flight period between burn and mint operations and avoids double-counting across chains.

20. The method of claim 11, further comprising generating balance snapshots at sub-second precision, each snapshot corresponding to a period without balance change and bounded by transfer events or market open/close times.
